(19) United States
(12) Patent Application Publication
(10) Pub. No.: US 2009/0145658 A1
(43) Pub. Date: Jun. 11, 2009

(54) Bridge for a wire harness or other electrical components

(76) Inventor: Charles H. Tafel, JR., Wixom, MI (US)

Correspondence Address: RAGGIO & DINNIN, P.C., 2701 CAMBRIDGE COURT, STE. 410, AUBURN HILLS, MI, 48326, US

(21) Appl. No.: 12/001,412

(22) Filed: Dec. 11, 2007

(51) Int. Cl. H01B 7/40

(52) U.S. Cl. 174/72 A

(57) ABSTRACT

A harness bridge member for retaining wires, harnesses or cables in a predetermined position on a member is disclosed. The harness bridge includes a substantially flat strap having a first side and a second side. It also includes a predetermined adhesive arranged on a predetermined portion of the first side of the strap. A predetermined adhesive is also arranged on a predetermined portion of a second side of the strap and a removable cover is arranged over the adhesive on the second side of the strap wherein the cover has a tab extending from one end thereof. The harness bridge is used to secure wires, harnesses, etc., within a vehicle by attaching to two different surfaces of the vehicle thus allowing for a more secure and robust connection at a predetermined position in the vehicle.

### BACKGROUND OF THE INVENTION

1. Field of the Invention

The subject invention generally relates to strap devices for holding wires, harnesses or other electrical components to a surface of a body and more particularly relates to a non-reusable self adhesive poly strap for holding wires, harnesses and other electrical components within a vehicle by forming a bridge between two surfaces of a vehicle.

2. Description of Related Art

It is well known in the prior art to use straps to secure wires, harnesses or other electrical components in vehicles and in other industrial equipment. One such type of attachment assembly in the prior art uses a flexible strap, a fastener that comprises portions adapted for releasable engagement attached on opposite ends of the strap and means for attaching the strap to the surface to which the wire harness or other object is being held. Typically these prior art straps may be attached to a surface and then wrapped around the object to be held in place and a fastener portion then engaged with one another. However, in some of these prior art fastener assemblies, many of the forces tend to dislodge the object from the fastener assembly and tend to peel apart at the fastener portions wherein the peeling is the easiest way of separating the fastener portions. Hence, many of these prior art fastener assemblies may not be as secured as desired due to the limited amount of resistance to such peel forces that can be easily designed in these fasteners. Many of these prior art systems also may have used metal brackets to secure the wire or harnesses within vehicles or other industrial equipment. However, these brackets may increase the cost due to materials used, and the amount of time necessary to install the brackets within the vehicle or other components.

Therefore, there is a need in the art for an improved flexible tape holder member that will bridge over wires or other electric components to permanently or temporarily hold a harness, wire or other electronic components in a predetermined position within an automotive vehicle or any other type of vehicle or industrial component. There also is a need in the art for a strap mechanism that will reduce the cost to the manufacturer in terms of time spent installing wiring harnesses, securing them to a vehicle and the amount of costs involved in the materials used to secure the wiring harnesses within a vehicle. There also is a need in the art for a reduced weight holder for use in holding wiring harnesses and the like within a vehicle or other industrial component. There also is a need in the art for a non-reusable strip that will securely hold a wire harness or other electrical component within a vehicle or the like. There also is a need in the art for a flexible poly strap that has adhesive on opposite ends and opposite sides thereof to create a bridge over a wire harness between two surfaces of a vehicle or other component in which the wire harness is used.

### SUMMARY OF THE INVENTION

One object of the present invention may be to provide an improved strap member for use in holding wires or electronic components in a vehicle.

Another object of the present invention may be to provide a flexible strap member made of a poly material for use in a vehicle.

Still another object of the present invention may be to provide a strap that may provide a bridge over wires or other electronic components in a vehicle or other industrial components that uses a flexible carrier film, foil or paper as a main component of the strap.

Yet another object of the present invention may be to provide a strap that may have predetermined sections of pressure sensitive adhesive thereon for use in permanently attaching and holding components to a vehicle surface.

Still another object of the present invention may be to provide a strap that may replace mechanical fasteners that are used in current vehicles to hold wire harnesses or other electrical components.

Still another object of the present invention may be to provide an adhesive strap that is capable of being applied to the component substrate either by hand or via a robot.

Still another object of the present invention may be to provide a poly strap that includes an adhesive on opposite ends and opposite sides thereof.

Still another object of the present invention may be to provide a poly strap that includes adhesives on both sides on one end only and on one end of the opposite side with no adhesive arranged within the middle portion thereof on either side thereof.

To achieve the foregoing objects, a bridge member for retaining wires, harnesses or cables in a predetermined position on a surface is disclosed. The bridge member includes a substantially flat strap having a first side and second side. The bridge also includes a predetermined adhesive arranged on a predetermined portion of the first side of the strap and a predetermined adhesive arranged on a predetermined portion of the second side of the strap. The strap also includes a removable cover arranged over the adhesive on the second side of the strap wherein the cover has a tab extending from one end thereof.

One advantage of the present invention may be that it provides a novel and improved strap system for holding wire harnesses or electrical components in a vehicle or other industrial component.

Still a further advantage of the present invention may be that it provides for a low cost and low weight system to hold wire harnesses or other electrical components onto a surface of a vehicle or other industrial component.

Yet another advantage of the present invention may be that it provides a loop over and bridge between two surfaces of a vehicle or other industrial component to hold a wire harness in a predetermined position.

Yet another advantage of the present invention may be that it provides for a flexible strap that includes a predetermined adhesive on opposite ends and opposite sides thereof.

Still another advantage of the present invention may be that it provides a strap with adhesive on both sides on one end and on one side of the opposite end with no adhesive being arranged on a middle portion of either side thereof.

Still another advantage of the present invention may be that it provides a non-reusable strap for holding wire harnesses or the like in an automotive vehicle.

Still another advantage of the present invention may be that the bridge strap may be initially arranged on the vehicle or other industrial component via either a human or a robot.

Other objects, features and advantages of the present invention will be apparent from the subsequent description and the appended claims, taken in conjunction with the accompanying drawings.

### BRIEF DESCRIPTION OF THE DRAWINGS

FIG. 1 shows a top view of a harness bridge according to the present invention.

FIG. 2 shows a side view of a harness bridge according to the present invention.

FIG. 3 shows an end view of a harness bridge according to the present invention.

FIG. 4 shows a side view of a harness bridge according to the present invention prior to holding of a wiring harness.

FIG. 5 shows a wiring harness being held by a bridge harness according to the present invention.

FIG. 6 shows a side view of a robot member that may be used with the bridge harness of the present invention to apply the bridge harness to a vehicle surface or the like.

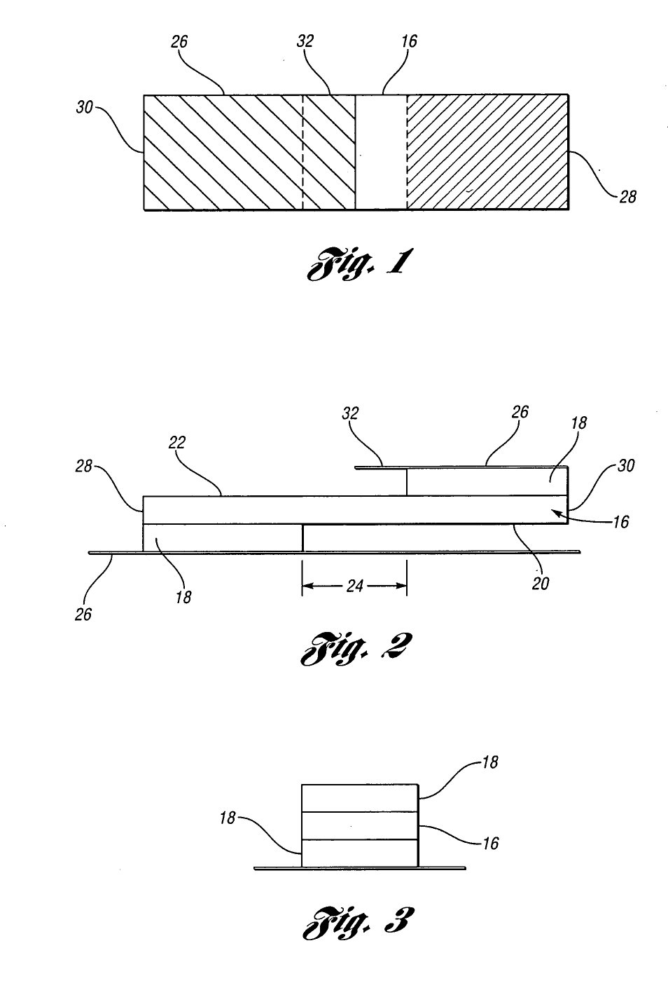

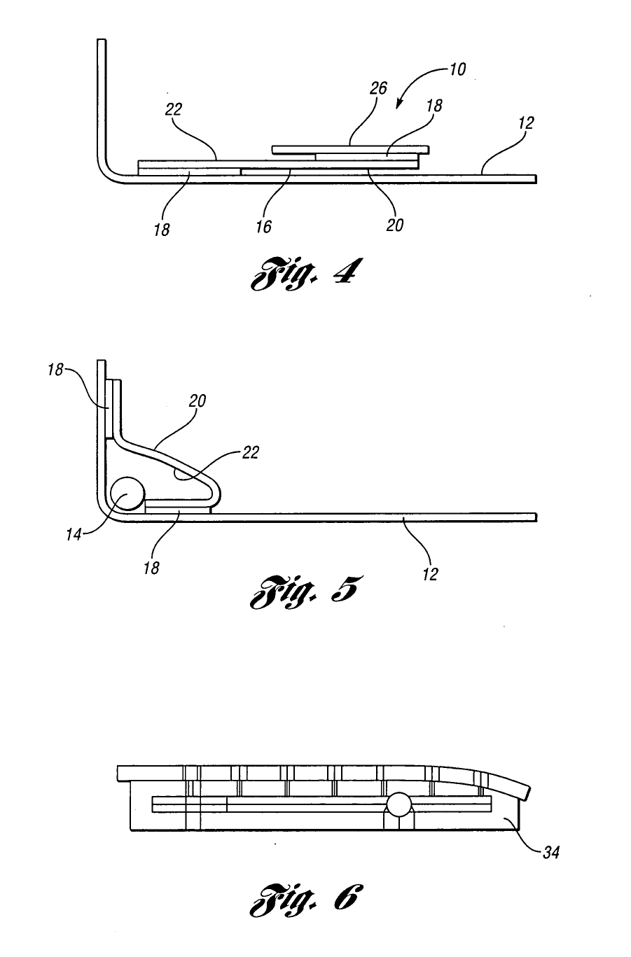

### BRIEF DESCRIPTION OF THE EMBODIMENT(S)

Referring to the drawings, a harness bridge member 10 for use with a vehicle, industrial machine or component 12 is shown. The harness bridge 10 may be used in any known vehicle 12, including but not limited, automotive vehicles, space vehicles, marine type vehicles, or any other vehicle and also in any known industrial machine, component or the like. The harness bridge 10 may be used in any setting that needs to secure and hold a wire harness or other electrical component 14 in a predetermined position therein. It should be noted that the bridge harness 10 may help to partially replace mechanical fasteners and clips now used in many harness holding applications. It should also be noted that the bridge harness 10 according to the present invention may be robotically applied to the vehicle or other component 12 in which the bridge harness 10 is necessary. Furthermore, the bridge harness 10 reduces the number of holes required in the sheet metal of vehicles and other components 12 thus reducing the manufacturing costs to the manufacturers of these vehicles and the like. Also, there is substantial cost savings with regards to weight and changes in optional equipment that might be needed in the prior art to secure wiring harnesses and the like in a vehicle or other industrial component. Therefore, the bridge member 10 of the present invention is capable of being used on its own to secure wire harnesses 14 or other components or to be used in conjunction with typical prior art mechanical fasteners, clips and the like.

Generally, the harness bridge 10 of the present invention includes a flexible strap or tape 16. The flexible strap 16 generally has a rectangular shape when viewed from a top. However, it should be noted that any other shape strap may be used for the present harness bridge 10 invention including but not limited to oval, square, triangular, random shapes, or the like. The strap 16 generally will be used to bridge over wires, harnesses or other electrical components 14 in order to permanently or temporarily secure these components 14 within a vehicle or other industrial component 12. In one contemplated embodiment the strap or tape 16 may be made of any known material, however in one contemplated embodiment a poly material is preferred. However, it should be noted that any other type of flexible plastic, ceramic, composite, natural material, or metal is contemplated to be used for the harness bridge 10 flexible strap 16 according to the present invention. It is also contemplated that the strap 16 may be made of any flexible carrier film, foil or paper tape to define the main body of the strap 16 in forming the harness bridge 10. It should be noted that any known contemplated overall dimensions may be used for the strap 16, however in one contemplated embodiment the strap 16 is approximately five inches in overall length and one inch in width. However, any other dimensions may be used for the harness bridge 10 depending on the application and the size of the wire, harness, cables 14 or the like that are being secured within a vehicle or other industrial application 12.

The strap 16 may consist of sections of adhesive 18 that may or may not be permanent for the use of attaching and holding of components such as harnesses, wires, cables 14 or the like within a vehicle 12. In one contemplated embodiment a pressure sensitive adhesive 18 may be applied to the strap 16 at predetermined positions thereon. However, it should be noted that any other type of adhesive 18, either permanent or removable may be used for the bridge harness 10 according to the present invention. In one contemplated embodiment a predetermined portion of a first side 20 of the strap 16 may have an adhesive 18 arranged thereon. The adhesive 18 extends a predetermined distance from a first end of the first side 20 of the strap 16. The strap 16 may have on a second side 22 another predetermined portion of adhesive 18 arranged thereon. This predetermined portion of adhesive 18 extends a predetermined distance from a second end of the second side 22 of the strap 16. It is contemplated that both sides of the strap 16 may use the same type of adhesive 18, however it is also contemplated that the opposite sides of the strap 16 may use different adhesives 18 to allow for different configurations of the bridge harness 10 in vehicles or other industrial components 12. It should be noted that in one contemplated embodiment the adhesive 18 on the first side 20 may extend from the first end a predetermined distance but not further than a mid point of the overall length of the strap 16 and the adhesive 18 arranged on the second side 22 extends from the second end of the strap 16 a predetermined distance but not greater than the mid point of the overall length of the strap 16. Hence, a gap 24 will be defined, having a predetermined size arranged about a mid point of the strap 16, in which no adhesive 18 is arranged on either the first side 20 or the second side 22. It should be noted that this gap 24 may be of any size from approximately a fraction of an inch all of the way up to many inches depending on the size of the overall bridge harness 10 according to the present invention. In one contemplated embodiment as shown in the drawings, the bridge harness strap 10 has an overall length of approximately five inches and each of the adhesive portions 18 extend approximately two inches from their respective end on the respective sides towards the middle of the strap 16. Therefore, this creates a gap 24 of approximately one inch between the adhesive portions 18 on the opposite sides 20, 22 of the strap 16. It should be noted that the adhesives 18 have a predetermined thickness which may be determined by the amount of adhesive 18 necessary to secure to sheet metal or other material in which the harness bridge 10 may be used. It should also be noted that the strap 16 may have a predetermined thickness depending on the amount of rigidity and strength needed in the strap 16 and the environment and in which a harness or the like will be secured.

It should be noted that in another contemplated embodiment a first end of the strap 16 will have an adhesive 18 arranged on both sides thereof while a second end of the strap 16 will only have an adhesive 18 arranged on one side thereof. This may allow the strap 16 to be used to one of two directions depending on which way the harness 10 is to be held in the vehicle or other industrial component 12 in which it is being used.

The strap 16 according to the present invention which may have the adhesive 18 arranged on both sides 20, 22 thereof and on opposite ends thereof may also include a liner or cover 26 arranged over the adhesive 18 after the adhesive 18 is placed onto the surface of the strap 16. The adhesive 18 on the second side 22 of the strap 16 extending from the second end 30 may completely cover the adhesive 18 and also include a predetermined length tab 32 extending from where the adhesive 18 ends on the strap 16. This tab 32 may allow for easy removal of the liner or cover 26 from the adhesive 18 for use in securing the harness bridge 10 to the vehicle 12 via the bridging over thereof. The first side 20 of the strap 16 having the adhesive 18 thereon may have a liner or cover 26 arranged over the adhesive 18 to ensure that the adhesive 18 is completely covered and in some other contemplated embodiments extends the entire length of the strap 16 to ensure for easy removal of the cover 26 before initial placement of the strap 16 onto a vehicle surface 12 by either a human or a robot arm 34. Generally, the liner or cover 26 is made of a paper material, however any other plastic, ceramic, composite, metal or natural material may be used for the covers 26 for use over the adhesive 18 to protect the adhesive 18 before they are needed for use in the vehicle or the like 12. In one contemplated embodiment the cover 26 over the adhesive 18 on the second side thereof may have a tab 32 of approximately one half inch to allow for easy removal of the cover 26 prior to securing of the harness 10 within the vehicle or the like 12. It should be noted that the tab 32 may be of any known size or shape, with any known dimensions.

In operation, the strap 16 generally is used to replace mechanical fasteners to hold electronic harnesses, wires, cables or other electrical components 12. In one contemplated embodiment the harness bridge 10 is applied via robotic interaction. A plurality of bridge harnesses 10 may be arranged on a robot station and a robot arm 34 using air suction or any other known lifting means will remove one harness bridge strap member 16 from the robot storage station and peel the cover 26 during lifting from the first side adhesive 18. The robot arm 34 will then shift into proper position with relation to a surface of the vehicle or other industrial component 12 and secure the strap 16 via the adhesive 18 on the first side 20 of the strap 16 to a surface of the vehicle 12 in a predetermined orientation with respect to the vehicle 12. The robotic arm 34 will ensure a proper engagement between the adhesive 18 and a surface of the vehicle 12 or the like. The robot arm 34 then returns to a predetermined position and the harness bridge member 10 is initially properly placed and aligned within the vehicle environment 12 to allow for securing a wire harness 14 or the like within the vehicle environment 12. After initial engagement and securement of the harness bridge 10 to the vehicle surface 12 the second side 22 of the strap 16 will be facing outward away from the surface 12 while the second end 30 will be hanging and not connected to any surface of the vehicle 12 initially. Next a wire harness 14 is inserted within the vehicle 12 and then a user or robot 34 will grasp the tab 32 on the cover 26 of the adhesive 18 on the second side 22 and near second end 30 of the harness bridge 10 and pull and remove the cover 26 from the adhesive 18 and then roll or fold over the second end 30 of the harness bridge 10 over the wire harness 14 being held in place in the vehicle 12 and secure the adhesive 18 on the second side 22 of the strap 16 to another portion of the surface of the vehicle 12. This creates a bridge effect over the wire harness 14 such that the second side 22 of the strap 16 will be engaged with a predetermined vehicle surface 12 and the first side 20 of the strap 16 will be engaged with the vehicle surface at another predetermined position thereof. This forming of a bridge may ensure that the wire harness may stay secured in its properly placed position by having contact with two surfaces, via the strap 16, to the vehicle 12 in which the wire harness is arranged. It is also contemplated that a robot 34 may perform the second operation of removing the cover 26 having the tab 32 therefrom and securing the second side 22 of the tape 16 to another vehicle surface 12. However, it is also contemplated that a human may perform both operations including the first initial engagement and securement of the wire bridge harness 10 first side 20 with the vehicle 12 and the final engagement of the strap 16 with the vehicle 12 to the second side 22 of the strap 16.

Therefore, the harness bridge 10 of the present invention may loop over and bridge a wire harness 14 between two surfaces of the vehicle 12 thus allowing for a more secure attachment of the wire harness 14 in a proper predetermined position within the vehicle 12 because of two connecting points to the vehicle surface 12 and not one as shown in prior art strap harnesses. It should also be noted that the vehicles can be made of any known metal material, ceramic material, composite material, or natural material and that the adhesives 18 may be formulated to be secured in a permanent or temporary manner to the vehicle surfaces such that the poly harness bridge 10 of the present invention may be used to completely replace or partially replace all known mechanical fasteners and clips now used in the prior art to hold wire harnesses therein. It should be noted that in one contemplated embodiment of the invention a predetermined portion of the adhesive 18 on the second side 22 of the tape 16 may engage with the first end 28 of the second side 22 of the tape 16 along with a surface of the vehicle 12 in which the wire harness 14 is being held. However, even in this embodiment there are still two separate portions of the strap 16 engaged with surfaces of the vehicle 12 in which the wire harness 14 is being secured therein.

The present invention has been described in an illustrative manner. It is to be understood that the terminology which has been used is intended to be in the nature of words of description rather than of limitation.

Many modifications and variations of the present invention are possible in light of the above teachings. Therefore, within the scope of the appended claims, the present invention may be practiced otherwise than as specifically described.

What is claimed is:

1. A bridge member for retaining wire harnesses or cables in a predetermined position on a surface of a member, said bridge including:
a substantially flat strap having a first side and a second side;
a predetermined adhesive arranged on a predetermined portion of said first side of said strap;
a predetermined adhesive arranged on a predetermined portion of said second side of said strap; and
a removable cover arranged over said adhesive on said second side of said strap, said cover having a tab on one end thereof.

2. The bridge of claim 2 wherein said strap is a flexible carrier film, foil or paper tape.

3. The bridge of claim 2 wherein said strap is a plastic or poly material.

4. The bridge of claim 1 wherein said adhesive is a pressure sensitive adhesive.

5. The bridge of claim 1 wherein said adhesive on said first side extends a predetermined distance from an end of said strap.

6. The bridge of claim 5 wherein said adhesive on said second side extends a predetermined distance from an opposite end of said strap.

7. The bridge of claim 1 wherein said adhesive on said first side is engaged with the surface of the member at a first predetermined position.

8. The bridge of claim 7 wherein said adhesive on said second side is engaged with the surface of the member at a second predetermined position after said cover is removed from said adhesive to hold the wire, harness or cable at a predetermined position on the member.

9. The bridge of claim 1 further including a removable cover arranged over said adhesive on said first side of said strap prior to engagement with the surface of the member.

10. The bridge of claim 1 wherein a predetermined gap is arranged between an end of said adhesive on said first side of said strap and an end of said adhesive on said second side of said strap.

11. A method of holding wires, harnesses or other electronic components in a predetermined position with relation to a surface of a member, said method including the steps of:
securing a flexible strap to the surface of the member by an adhesive arranged on a first side of said strap;
removing a cover from an adhesive arranged on a second side of said strap;
arranging said second side of said strap over the wires to form a bridge thereover; and
securing said second side of said strap to the surface of the member by said adhesive arranged on said second side of said strap.

12. The method of claim 11 wherein said flexible strap is made of a carrier film, foil or paper tape.

13. The method of claim 12 wherein said strap is made of a poly material.

14. The method of claim 11 wherein said first side is secured to the surface of the member by a robot.

15. The method of claim 11 wherein said first side is secured to the surface of the member by a human.

16. The method of claim 11 wherein said second side is secured to the surface of the member by a human.

17. The method of claim 11 wherein said cover having a tab to allow for easy removal thereof.

18. The method of claim 11 wherein said adhesive is a pressure sensitive adhesive.

19. The method of claim 11 wherein said adhesive extends a predetermined distance from a first end.

20. The method of claim 19 wherein said adhesive extends a predetermined distance from a second end such that a predetermined middle portion of said strap has no adhesive on either of said sides.
